(19) United States
(12) Patent Application Publication
(10) Pub. No.: US 2014/0262998 A1
(43) Pub. Date: Sep. 18, 2014

(54) Water System

(71) Applicants: Chris Wagner, Pearlang, TX (US); Dusty Williams, Pearlang, TX (US)

(72) Inventors: Chris Wagner, Pearlang, TX (US); Dusty Williams, Pearlang, TX (US)

(21) Appl. No.: 13/840,288

(22) Filed: Mar. 15, 2013

(51) Int. Cl. E03B 3/02; E03B 3/03; C02F 1/32; C02F 1/00

(52) U.S. Cl. CPC E03B 3/02; C02F 1/008; E03B 3/03; C02F 1/325
USPC 210/143; 210/170.03; 210/251

(57) ABSTRACT

A water distribution system for the distribution of water may include a collection and filtering device to collect and filter water for the water distribution system, a Hydro turbine generator to generate power from the collected water and a storage tank to store water from the Hydro generator.

### FIELD OF THE INVENTION

The present invention relates to a system for gathering and distributing water.

### BACKGROUND

Potable (i.e., drinkable) water is a necessity to which millions of people throughout the world have limited access. Water is often considered to be the most basic and accessible element of life, and seemingly the most plentiful. In every liter of water in rivers or lakes, fifty more lie buried in vast aquifers beneath the surface of the earth. There is no standard for the quantity of water a person needs each day but experts often place the minimum at 100 liters for adults. Most people drink one or two liters, with the rest typically being used for cooking, bathing, and sanitation. Adult Americans consume between 400 and 600 liters of water each day.

Additionally, water is a necessity for agriculture, lawns and gardens. When there is insufficient rain, the deficiency must be made up from other sources.

### SUMMARY

A water distribution system for the distribution of water may include a collection and filtering device to collect and filter water for the water distribution system, a Hydro turbine generator to generate power from the collected water and a storage tank to store water from the Hydro generator.

The collection and filter device may be located on the roof of the dwelling.

The collection and filter device may be connected to a input for a washing machine.

The collection and filter device may be connected to an input for an air conditioner.

The collection and filter device may include a input to a condensation tank.

The water distribution system may include a multi input collection chamber.

The multi input collection chamber may include ultraviolet light.

The multi input collection chamber may include micron filtering.

The collection and filter device may include a weather sensing device to control the weather distribution system.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a portion of the water distribution system of the present invention;

FIG. 2 illustrates another portion of the water distribution system of the present invention;

FIG. 3 illustrates another portion of the water distribution system of the present invention;

FIG. 4 illustrates another portion of the water distribution system of the present invention.

### DETAILED DESCRIPTION

The present invention collects water from the rain and other means in your household. The present invention uses this water to make power by hydro turbine, wind, solar with a grid tie-in system connected to the house to provide power. This unit of the present invention can also be tied to the house to supply water as well. In addition to that listed above, the present invention may include a weather sensing device that controls the unit valve systems and watering cycles for distributing the water to the house landscape, pool etc. in accordance with detected weather conditions. The unit of the present invention may include of retaining lines that run from the various water sources to a first stage collection point. These lines may be the first point of access for the process for filtering the water connected to our sump filter separator. Second, the water may be then diverted via gravity pressure to a multi input collection chamber of a filter or second stage filtration. This water may pass thru ultra violet light and micron filtering and water stabilization devices to make potable water. Third, the water storage point and water stabilization process may include an ultra violet recirculation system. On the side or top of the water storage tank may include a water measuring indicator on the surface of the tank. Fourth, the unit of the present invention may include an over flow protection line or an additional input line feed. This line can also be used to generate additional power by using a hydro turbine once storage tanks begin to overflow. Fifth, the present invention may include a platform box inside the power generation access distributor box and power storage point along with the water management system to supply various water needs. The unit of the present invention can be permanently installed and portable for other applications.

FIGS. 1, 2, 3 and 4 may be combined to illustrate water distribution system of the present invention.

First stage of collection and filtering device 1 of the present invention collects water at the top of the unit generally by collecting water which falls on a roof or other means of water collection. The weather sensors may be located with the filtering device 1. The water may flow (the term flowing means flowing through a pipe or comparable device) through a filtering screen 2 by the unit entry point. Next under the water intake is multi-input water ports including the washing machine input 3, air conditioner input 4, the condensation tank input 5, and first stage of power making by using a hydro turbine generator 6 for generating electric power from water flow from the above water producing devices. After the generator 6, is the input 7 to the storage tanks and sump trap connecting tee. The tee side leading to the storage tanks may include multiple screens for filtering which is located inside the part of the storage tanks. The opposing side of the connecting tee may not be equipped with a screen so debris can fall to the collection trap. The bottom side of the connecting tee is where the heavy and big debris is than trapped in a collection tube 8. The collector tube 8 may be clear or non transparent which may be serviced by using a ball joint valve to dump heavy rocks, sand, leaves and other solids. Directly under the trap is the collection bucket 8 to hold the debris coming out of the collection tube 8.

Second stage of the unit may include the water running through to the opposing side of the input connecting tee 7, and the water may have already passed through the filtering screens positioned internal to the input connecting tee 7. Filtration input drop lines 9 may include the filtered water drop line connecting tee and tank to tank transfer pipe. The filtration input drop lines 9 may connect the two storage tanks for filtered and unfiltered water storage. After the water tanks are filled, the filtration input drop lines 9 functions as a tank overflow protection line and may include a hydro generator being positioned internal to harness more available power by the water overflow.

Third, the water may flow to the multi input collection chamber 10 which may be positioned directly above both storage tanks which may include a service valve at the bottom of the storage tanks. These service valves may serve as a sight glass for inspection cleaning purposes. Next, after the water has flowed through the multi input collection chamber the water may flow through an ultra violet lighting device 11 and continue to flow through micron filter screens 12 to further sanitize the water. The ultraviolet lighting device 11 and the micron filter screens 12 may be mounted to the unit storage tank. The water then flows through another ultraviolet screening recirculation pump 13 positioned inside the storage tank. The recirculation pump 13 includes ultra violet lighting for water sanitation and balance.

Fourth, the water storage tank 14 may be shaped in different volumes and shapes depending on the need of the user and may be formed from plastic or metal or other appropriate material. The tank 14 may include water pump tie and storage drain exit valve 15 at the bottom of the storage tank 14 which may be used to drain or transport water by gravity or an electric pump. The storage tank 14 also include a volume measuring gauge along the side of the storage tank 14 and a gauge at the top of the storage tank 14. These gauges may be an additional option. The water storage tank pump may include intake lines for the recirculation pump connected to the water pump tie and storage drain. After the storage tank 14, the water runs to a water pump 16 then through an electric solenoid valve 17 to a check valve 18. The solenoids 17 and check valves 18 control the water flow and direction and are controlled by the weather sensing device and weather management system. The weather sensing device and weather management station is located by the solar/wind/Hydro control box 38. Next in line, water flows to a three way connecting tee 19 with one side connecting water to the city water main and the other side connecting to the house. The third side of the connecting tee 19 connects the water to the landscape line. The connecting tee 19 will connect to the house's existing water main where the filtered water connects to the existing house water main. The water flows through the water tee 19 to a solenoid valve 20, check valve 21 and on to the three way venturi valve 22. The filtered water storage tank 14 is connected to flow water into the house main water line after the house water meter. On the opposing side of the three way water tee 19, the water is connected to flow to a solenoid valve 23, check valve 24 and then a venturi valve connection tee 25 to connect to the main water line and filtered water tank exit input. This connection allows the city or well water pressure to pull water from the filtered water storage tank 14 and unfiltered water storage tank 30. Both the filtered and unfiltered water may be mixed together with the city or well water to supply the needs of the landscape, pool, garden, etc. Now before the water from the main water line reaches the venturi tee 25 to connect the filtered water and unfiltered water it has a one way check valve 26 and a electric control solenoid valve 27 to the city water input. Next the water flowing from the input connecting tee 7 to the multi input port 28 for the unfiltered water storage tank 30 after the multi input collection chamber water will run through the connection lines 29 to the unfiltered water storage tank 30. The tank 30 may include a sight gauge like the filtered water tank and may include a similar tank exit valve. After the unfiltered water storage tank valve, the water is connected and flows to a water pump 31, solenoid valve 32, and a check valve 33. Next in line, after the (25) venturi tee 25 and unfiltered water storage tank output, water flows to another check valve 34 and hydro turbine generator 34. After the water flows through the generator 34 the water is delivered to the landscape, pool, garden, etc.

The main water line before it goes into the home may be connected to the hydro turbine 35. The house may be attached to a solar panel 36, wind generator 37, solar, wind, and hydro power control box 38 to control the solar, wind, and Hydro. Mounted above the storage tanks 14, 30 may be a battery box and battery power 39, pump distribution controller box 40 which controls the unit functions and weather inputs and potentially stores this information on a local hard drive. This storage of weather data will better manage water availability and power management. Along with the grid tie in inverter and battery power source 41, which is mounted next to an additional water pump and distributor valve 42 will be found to provide water for other means of use.

A control platform box may be located under the multi-port collection chamber and above the storage tank. This platform holds the unit's power management system, power storage, unit timer distribution control box support, and metal/plastic housing to further protect the other components. On the platform is the power management system which ties into the house to provide additional power by using a transport grid tie cable. The platform may also holds the pressure pump 42 of the present invention which can be set for a certain gallons per minute flow rate or specification as needed. The venturi valves of the present invention may use the pressure from each of the storage tanks by means of gravity, pump pressure, and city water main pressure. The present invention may more environmentally friendly and subsequently more effective in both generating energy and conserving water.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A water distribution system for the distribution of water, comprising:
a collection and filtering device to collect and filter water for the water distribution system;
a Hydro turbine generator to generate power from the collected water;
a storage tank to store water from the Hydro generator.

2) A water distribution system for the distribution of water as in claim 1, wherein the collection and filter device is located on the roof of the dwelling.

3) A water distribution system for the distribution of water as in claim one, wherein the collection and filter device is connected to a input for a washing machine.

4) A water distribution system for the distribution of water as in claim 1, wherein the collection and filter device is connected to an input for an air conditioner.

5) A water distribution system for the distribution of water as in claim 1, wherein the collection and filter device includes a input to a condensation tank.

6) A water distribution system for the distribution of water as in claim 1, wherein the water distribution system includes a multi input collection chamber.

7) A water distribution system for the distribution of water as in claim 6, wherein the multi input collection chamber includes ultraviolet light.

8) A water distribution system for the distribution of water as in claim 6, wherein the multi input collection chamber includes micron filtering.

9) A water distribution system for the distribution of water as in claim 1, wherein the collection and filter device includes a weather sensing device to control the weather distribution system.
